(19) United States
(12) Patent Application Publication
(10) Pub. No.: US 2005/0289273 A1
(43) Pub. Date: Dec. 29, 2005

(54) Communication apparatus using inter integrated circuit bus and communication method thereof

(76) Inventors: Bong-geun Lee, Suwon-si (KR); Kab-keun Lee, Suwon-si (KR); Dong-hoon Han, Suwon-si (KR); Kun-tae Kim, Suwon-si (KR)

Correspondence Address: STANZIONE & KIM, LLP, 919 18TH STREET, N.W., SUITE 440, WASHINGTON, DC, 20006, US

(21) Appl. No.: 11/028,609

(22) Filed: Jan. 5, 2005

(30) Foreign Application Priority Data
Jun. 25, 2004 (KR) 2004-48299

(51) Int. Cl. G06F 13/24

(52) U.S. Cl. 710/260

(57) ABSTRACT

A communication apparatus that communicates with an external apparatus using an I²C bus, the communication apparatus having a microprocessor to process data received in response to an interrupt activation signal, a first reception unit to receive data transmitted from the external apparatus through the I²C bus and temporarily store the data until the data becomes a predetermined unit, and a second reception unit to generate the interrupt activation signal and to transmit the data of the predetermined unit to the microprocessor.

### CROSS-REFERENCE TO RELATED APPLICATIONS

This application claims the benefit of priority under 35 U.S.C. § 119 of Korean Patent Application No. 2004-48299 filed Jun. 25, 2004, in the Korean Intellectual Property Office, the disclosure of which is incorporated herein by reference.

### BACKGROUND OF THE INVENTION

1. Field of the Invention

The present general inventive concept relates to a communication apparatus using an inter integrated circuit (I²C) bus and a communication method thereof, and more particularly, to a communication apparatus using an I²C bus and a communication method thereof, capable of preventing collisions between microprocessors by connecting independent microprocessors through input/output (I/O) expanders.

2. Description of the Related Art

I²C is an abbreviation of inter integrated circuit and is also referred to as an IIC. An I²C bus includes two lines to transmit information between various devices. One line is used for serial data (SDA) and the other line is used for serial clock (SCL).

FIG. 1 is a block diagram of a conventional communication system using an I²C bus.

Referring to FIG. 1, microprocessors (not shown) are mounted on first and second communication apparatuses 100 and 200 which perform independent functions. The microprocessors transceive serial data through the I²C bus.

That is, the first and second communication apparatuses 100 and 200 are connected through the I²C bus, and the data is transceived therebetween. When transmitting the data through only one I²C bus, a data transmission direction must be determined. Therefore, two interrupts are used to determine the data transmission direction in the I²C bus.

As shown in FIG. 1, when transmitting the data from the first communication apparatus 100 to the second communication apparatus 200, an interrupt A is activated and then the data is transmitted. At this point, the first communication apparatus 100 acts as a master and sets its I²C port as an output port, and the second communication apparatus 200 acts as a slave and sets its I²C port as an input port.

Also, when transmitting the data from the second communication apparatus 200 to the first communication apparatus 100, an interrupt B is activated, and then data is transmitted. At this point, the second communication apparatus 200 acts as the master and sets its I²C port as the output port, and the first communication apparatus 100 acts as the slave and sets its I²C port as the input port.

As compared with the system which performs communication through only one I²C bus, the above-described communication system can transceive signals more stably. However, there is a possibility that an error may occur in the data transmission due to program execution periods of the microprocessors mounted on the first and second communication apparatuses 100 and 200, due to a priority of a currently executing program, and so on.

Further, in order to transmit/receive the serial data between the first and second communication apparatuses 100 and 200, the respective I²C port must be changed into either the output port or the input port. At this point, even though the respective first and second communication apparatuses 100 and 200 use the clock provided by the I²C bus, the clock at each communication apparatus 100 and 200 will not be completely identical. Accordingly, there occurs a problem of determining when to transmit the serial data, after activating the interrupts A or B, through the I²C bus.

That is, a timing error may occur when the first and second communication apparatuses 100 and 200 change their respective I²C port into the input or output port. Therefore, if the data is transmitted before one of the first and second communication apparatuses 100 and 200 changes its I²C port into the input or output port, the data may be lost.

### SUMMARY OF THE INVENTION

Accordingly, the present general inventive concept provides a communication apparatus using an I²C bus and a communication method thereof, in which independent microprocessors transmitting/receiving data through the I²C bus are connected to an I/O (input/output) expander acting as a buffer.

Additional aspects and/or advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a communication apparatus to transmit/receive data to/from an external apparatus through an I²C bus, the communication apparatus including a microprocessor to process data received in response to an interrupt activation signal, a first reception unit to receive data transmitted from the external apparatus through the I²C bus and to temporarily store the received data until the received data becomes a predetermined unit, and a second reception unit to generate the interrupt activation signal and to receive from the first reception unit and to transmit to the microprocessor the data of the predetermined unit.

The first reception unit may include a first I/O expander to receive the data transmitted from the external apparatus through the I²C bus and to convert the received data into 8-bit data to be transmitted.

The second reception unit may include a second I/O expander to convert the 8-bit data into serial data to be transmitted.

The data transmission between the second reception unit and the microprocessor may be performed through the I²C bus.

The microprocessor may transmit the processed data to the external apparatus through the I²C bus.

The foregoing and/or other aspects and advantages of the present general inventive concept are also achieved by providing a communication method of a communication apparatus using an I²C bus, the communication method including receiving data from an external apparatus through the I²C bus at a first reception unit, temporarily storing the received data until the received data becomes a predetermined unit and transmitting the data of the predetermined unit to a second reception unit, generating an interrupt activation signal at the second reception unit, transmitting the data received by the second reception unit to the microprocessor, and processing the data received by the microprocessor.

The operation of receiving data from the external apparatus through the I²C bus at the first reception unit may further include operations of converting the data transmitted through the I²C bus from the external apparatus into 8-bit data and transmitting the 8-bit data to the second reception unit.

The operation of transmitting the data received by the second reception unit may further include operations of converting the 8-bit data into serial data at the second reception unit and transmitting the serial data to the microprocessor.

The transmitting of data to the microprocessor may be performed through the I²C bus.

The communication method may further include the operation of transmitting the data processed by the microprocessor to the external apparatus.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional communication system using an I²C bus;

FIG. 2 is a block diagram of a communication system having communication apparatuses using an I²C bus according to an embodiment of the present general inventive concept;

FIG. 3 is a block diagram of a first I/O expander shown in FIG. 2;

FIG. 4 is a block diagram of a second I/O expander shown in FIG. 2; and

FIG. 5 is a flowchart illustrating a communication method of a communication apparatus using an I²C bus according to an embodiment of the present general inventive concept.

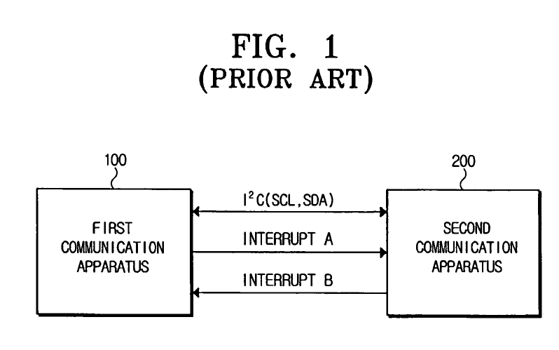

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

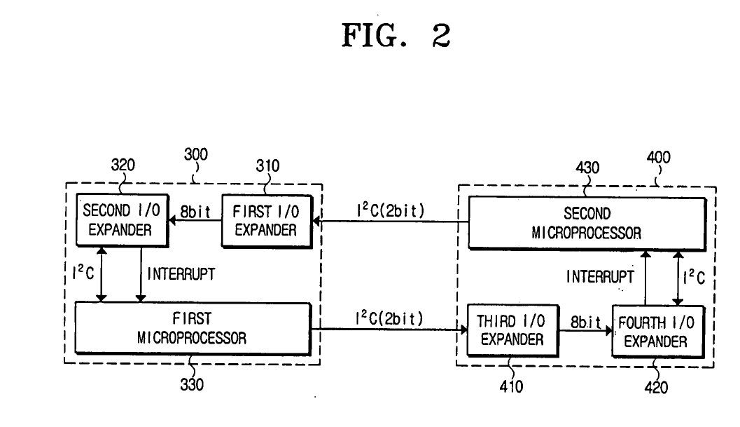

FIG. 2 is a block diagram of a communication system having communication apparatuses 300 and 400 using an inter integrated circuit (I²C) bus according to an embodiment of the present general inventive concept.

Here, a first communication apparatus (300 or 400) is connected with an external apparatus, i.e., a second communication apparatus (400 or 300), so as to transceive data therebetween. Referring to FIG. 2, the first and second communication apparatuses 300 and 400, or 400 and 300, are connected to each other through the I²C bus. For simplicity purposes, the communication apparatus 300 will be referred to as the first communication apparatus and the communication apparatus 400 will be referred to as the second communication apparatus.

The first communication apparatus 300 according to the embodiment of FIG. 2 includes a first transceiver unit, a second transceiver unit, and a first microprocessor 330, and the second communication apparatus 400 includes a first transceiver unit, a second transceiver unit, and a second microprocessor 430.

Here, first and second input/output (I/O) expanders 310 and 320 are the first and second transceiver units of the first communication apparatus 300, respectively. Also, third and fourth I/O expanders 410 and 420 are the first and second transceiver units of the second communication apparatus 400, respectively.

To explain a case where data is transmitted from the second communication apparatus 400 to the first communication apparatus 300, the first I/O expander 310, the second I/O expander 320 and the first microprocessor 330 will now be described.

The first I/O expander 310 receives serial data (SDA) transmitted from the second microprocessor 430 of the second communication apparatus 400 through the I²C. The first I/O expander 310 temporarily stores the received serial data until the received serial data becomes a predetermined unit, and then outputs the serial data of the predetermined unit to the second I/O expander 320.

The second I/O expander 320 receives the serial data of the predetermined unit and generates an interrupt activation signal to alert the first microprocessor 330 to prepare to receive the serial data of the predetermined unit.

The first microprocessor 330 prepares to receive the serial data of the predetermined unit in response to the interrupt activation signal generated from the second I/O expander 320 and processes the serial data transmitted from the second I/O expander 320.

Similarly, if data is transmitted from the first communication apparatus 300 to the second communication apparatus 400, the third I/O expander 410, the fourth I/O expander 420 and the second microprocessor 430 perform the above-described functions of the first I/O expander 310, the second I/O expander 320 and the first microprocessor 330, respectively.

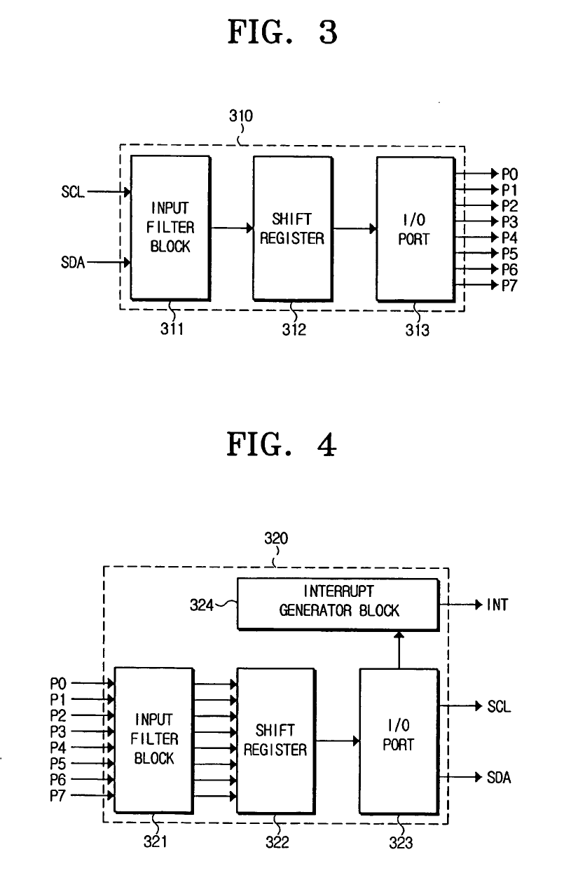

FIG. 3 is a block diagram of the first I/O expander 310 shown in FIG. 2. The first I/O expander 310 of the first communication apparatus 300 shown in FIG. 2 will be described in greater detail with reference to FIG. 3. The third I/O expander 410 of the second communication apparatus 400 has the same construction as the first I/O expander 310.

The first I/O expander 310 according to the present embodiment includes an input filter block 311, a shift register 312, and an I/O port 313.

The input filter block 311 receives the serial data transmitted from the second microprocessor 430 of the second communication apparatus 400 through the I²C bus and outputs the serial data, whose noise is filtered out, to the shift register 312.

The shift register 312 receives the filtered serial data from the input filter block 311 and temporarily stores the filtered serial data until the filtered serial data becomes a predetermined unit (e.g., 8 bits), and outputs the serial data of the predetermined unit to the I/O port 313.

The shift register 312 can be configured with a plurality of D-flip flops connected in series. The shift register 312 stores or shifts the filtered serial data. Due to the shift register 312, the first I/O expander 310 can serve as a buffer to temporarily store the filtered serial data.

The I/O port 313 converts the output data of the shift register 312 into 8-bit data P0 to P7 and outputs the 8-bit data to the second I/O expander 320.

FIG. 4 is a block diagram of the second I/O expander 320 shown in FIG. 2.

The second I/O expander 320 of the first communication apparatus 300 shown in FIG. 2 will be described in more detail with reference to FIG. 4. In the present embodiment, the fourth I/O expander 420 of the second communication apparatus 400 has the same construction as the second I/O expander 320.

Like the first I/O expander 310, the second I/O expander 320 includes an input filter block 321, a shift register 322, and an I/O port 323. Also, the second I/O expander 320 further includes an interrupt generator block 324.

The input filter block 321 receives 8-bit data P0 to P7 from the I/O port 313 of the first I/O expander 310 and outputs filtered 8-bit data to the shift register 322.

The shift register 322 temporarily stores the output data of the input filter block 321 and outputs the temporarily stored data to the I/O port 323.

The I/O port 323 converts the output data of the shift register 322 into serial data.

If the temporarily stored data is input from the shift register 322 to the I/O port 323, the interrupt generator block 324 generates the interrupt activation signal and outputs an interrupt INT to the microprocessor. The first microprocessor 330 is ready to receive serial data from I/O port 323 in response to the interrupt activation signal.

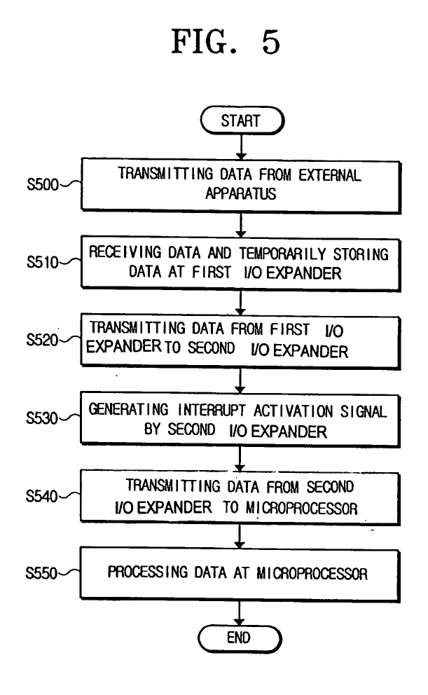

FIG. 5 is a flowchart illustrating a communication method of the communication apparatus of FIG. 2 using the I²C bus, according to an embodiment of the present general inventive concept.

A communication method between the first and second communication apparatuses 300 and 400 transmitting/receiving data through the I²C bus will now be described with reference to FIGS. 2 through 5.

The serial data is transmitted from the second microprocessor 430 of the second communication apparatus 400 to the first I/O expander 310 of the first communication apparatus 300 (operation S500).

The input filter block 311 of the first I/O expander 310 receives the serial data transmitted from the second microprocessor 430 of the second communication apparatus 400, and the shifter register 312 temporarily stores the serial data until the serial data becomes the predetermined unit (i.e., 8 bits). When the stored serial data becomes the predetermined unit, the shift register 312 outputs the data of the predetermined unit through the I/O port 313 (operation S510).

Next, the 8-bit data of the predetermined unit is sequentially transmitted from the I/O port 313 of the first I/O expander 310 through the input filter block 321 to the shift register 322 of the second I/O expander 320 (operation S520). The interrupt generator block 324 of the second I/O expander 320 generates the interrupt activation signal (operation S530).

Here, the interrupt activation signal generated from the interrupt generator block 324 of the second I/O expander 320 is inputted to the first microprocessor 330. Accordingly, the first microprocessor 330 is ready to receive data in response to the interrupt activation signal.

Next, the data of the predetermined unit is transmitted to the first microprocessor 330 through the I/O port 323 of the second I/O expander 320 (operation S540). The first microprocessor 330 receives and processes the data output from the I/O port 323 (operation S550).

Although the data transmission from the second communication apparatus 400 to the first communication apparatus 300 has been described above, the above-described method can also be applied to data transmission from the first communication apparatus 300 to the second communication apparatus 400.

As described above, the first and second microprocessors 330 and 430, respectively, are independent and located in the first and second communication apparatuses 300 and 400 respectively, which are connected to each other not directly but through the first I/O expander 310, which performs the buffer function, and the second I/O expander 320, which performs the interrupt function.

Thus, it is possible to prevent an error from occurring in a timing of a data transmission or a data reception between two apparatuses. Accordingly, data loss can be prevented and collisions between microprocessors of the two apparatuses can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A communication apparatus to transmit/receive data to/from an external apparatus through an I²C bus, the communication apparatus comprising:
a microprocessor to process data received in response to an interrupt activation signal;
a first reception unit to receive data transmitted from the external apparatus through the I²C bus and temporarily store the data until the data becomes a predetermined unit; and
a second reception unit to generate the interrupt activation signal and receive from the first reception unit and transmit to the microprocessor the data of the predetermined unit.

2. The communication apparatus of claim 1, wherein the first reception unit comprises:
a first I/O (input/output) expander to receive the data transmitted from the external apparatus through the I²C bus and convert the received data into 8-bit data to output to the second reception unit.

3. The communication apparatus of claim 2, wherein the second reception unit comprises:
a second I/O expander to convert the 8-bit data into serial data to output to the microprocessor.

4. The communication apparatus of claim 3, wherein the first I/O expander comprises:
an input filter block to receive the serial data transmitted from the external apparatus and to filter and output the serial data;
a shift register to receive the filtered serial data from the input filter block and temporarily store the filtered serial data until the filtered serial data becomes the predetermined unit, and then outputs the data of the predetermined unit; and
an I/O port to convert the output data of the shift register into 8-bit data and output the 8-bit data to the second reception unit.

5. The communication apparatus of claim 4, wherein the second I/O expander comprises:
a second input filter block to receive the 8-bit data from the I/O port and filters and outputs the 8-bit data;
a second shift register to temporarily store and then output the data output from the second input filter block;
a second I/O port to convert the data output from the second shift register to the serial data.

6. The communication apparatus of claim 1, wherein the data transmitted between the second reception unit and the microprocessor is performed through the I²C bus.

7. The communication apparatus of claim 1, wherein the microprocessor transmits the processed data to the external apparatus through the I²C bus.

8. The communication apparatus of claim 1, wherein the first and second reception units are transceivers.

9. A communication method of a communication apparatus using an I²C (inter integrated circuit) bus, the communication apparatus being connected with an external apparatus through the I²C bus, the communication apparatus comprising a first reception unit to receive data from the external apparatus; a second reception unit to receive output data of the first reception unit; and a microprocessor to receive output data of the second reception unit, the communication method including the operations of:
receiving data from the external apparatus through the I²C bus at the first reception unit, temporarily storing the data until the data becomes a predetermined unit, and transmitting the data of the predetermined unit to the second reception unit;
generating an interrupt activation signal at the second reception unit;
transmitting the data received by the second reception unit to the microprocessor; and
processing the data received by the microprocessor.

10. The communication method of claim 9, wherein the operation of receiving data from the external apparatus through the I²C bus at the first reception unit further includes operations of:
converting the data transmitted through the I²C bus from the external apparatus into 8-bit data; and
transmitting the 8-bit data to the second reception unit.

11. The communication method of claim 10, wherein the operation of transmitting the data received by the second reception unit includes the operations of:
converting the 8-bit data into serial data at the second reception unit; and
transmitting the serial data to the microprocessor.

12. The communication method of claim 10, wherein the transmitting of data to the microprocessor is performed through the I²C bus.

13. The communication method of claim 10, further comprising the operation of transmitting the data processed by the microprocessor to the external apparatus.

14. A communication method to communicate between microprocessors through an I²C bus, comprising:
receiving data at a first location from a first microprocessor through the I²C bus and temporarily storing the received data at the first location until the data becomes a predetermined unit;
receiving the data as the predetermined unit at a second location and generating an interrupt activation signal at the second location;
transmitting the data received by the second location to a second microprocessor; and
processing the received data at the second microprocessor.

15. A communication system to communicate between two communication apparatuses, comprising:
an I²C bus to transmit data therethrough; and
first and second communication apparatuses each including:
a first transceiver unit to receive serial data transmitted from a microprocessor of the other one of the first and second communication apparatuses through the I²C bus and to temporarily store the received serial data until the received serial data becomes a predetermined unit, and then output the data of the predetermined unit,
a second transceiver unit to receive the data of the predetermined unit output by the first transceiver unit and to generate an interrupt activation signal notifying to prepare to receive data, and
and a microprocessor to receive the data in response to the interrupt activation signal and to process the data received from the second transceiver unit.

16. The communication system of claim 15, wherein the first transceiver unit comprises:
a first I/O (input/output) expander to receive the data transmitted from the microprocessor of the other one of the first and second communication apparatuses through the I²C bus and convert the received data into 8-bit data to output to the second transceiver unit.

17. The communication system of claim 17, wherein the second transceiver unit comprises:
a second I/O expander to convert the 8-bit data into serial data to output to the microprocessor.

18. The communication system of claim 17, wherein the first I/O expander comprises:
an input filter block to receive the serial data transmitted from the microprocessor of the other one of the first and second communication apparatuses and to filter and output the serial data;
a shift register to receive the filtered serial data from the input filter block and temporarily store the filtered serial data until the filtered serial data becomes the predetermined unit, and then outputs the data of the predetermined unit; and
an I/O port to convert the output data of the shift register into 8-bit data and output the 8-bit data to the second transceiver unit.

19. The communication system of claim 18, wherein the second I/O expander comprises:
a second input filter block to receive the 8-bit data from the I/O port and filters and outputs the 8-bit data;
a second shift register to temporarily store and then output the data output from the second input filter block; and
a second I/O port to convert the data output from the second shift register to the serial data.

20. The communication system of claim 15, wherein the data transmitted between the second transceiver unit and the microprocessor is performed through the I²C bus.

21. The communication system of claim 15, wherein the microprocessor transmits the processed data to the other one of the first and second communication apparatuses through the I²C bus.
